(19) United States
(12) Patent Application Publication
(10) Pub. No.: US 2008/0185091 A1
(43) Pub. Date: Aug. 7, 2008

(54) Sheet bonding machine, image forming apparatus including same, and sheet bonding method

(75) Inventors: Kazuhisa Sudo, Kanagawa (JP); Mikio Ishibashi, Kanagawa (JP); Reki Nakamura, Kanagawa (JP); Megumi Ohtoshi, Kanagawa (JP); Yukiko Iwasaki, Kanagawa (JP); Nobuyuki Koinuma, Kanagawa (JP); Takashi Sakamaki, Kanagawa (JP); Kazuhiko Yuki, Kanagawa (JP); Ryuji Yoshida, Kanagawa (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/068,223

(22) Filed: Feb. 4, 2008

(30) Foreign Application Priority Data
Feb. 5, 2007 (JP) 2007-025744
Jul. 30, 2007 (JP) 2007-197213

(51) Int. Cl. B29C 65/72

(52) U.S. Cl. 156/201; 156/459; 156/378

(57) ABSTRACT

A sheet bonding machine for bonding first sheet and a second sheet together includes a transport part, an angling member, and a pressure bond part. The transport part is configured to transport the first sheet and the second sheet and contact the first and the second sheet against each other at a predetermined angle. The angling member is configured to bend at least one of the first sheet and the second sheet. The pressure bond part is provided downstream of a contact position between the first sheet and the second sheet and configured to bond together with pressure the first sheet and the second sheet contacted against each other.

### CROSS-REFERENCE TO RELATED APPLICATIONS

This patent specification claims priority to Japanese Patent Application Nos. JP2007-025744, filed on Feb. 5, 2007, and JP2007-197213 filed on Jul. 30, 2007 in the Japan Patent Office, the entire contents of each of which are hereby incorporated by reference herein.

### BACKGROUND OF THE INVENTION

1. Field of the Invention

The present invention generally relates to a sheet bonding machine, an image forming apparatus including the sheet bonding machine, and a sheet bonding method.

2. Discussion of the Background Art

At present, various sheets are formed by bonding two sheets. For example, an image record sheet as glossy as a photograph can be readily produced by forming a mirror image on a transparent sheet through an electrographic image forming method and bonding the transparent sheet and a white sheet together with the mirror image sandwiched therebetween. Adhesive is sprayed on an image surface of the transparent sheet, and then the transparent sheet is bonded to the white sheet.

FIG. 1 illustrates a process to form such a glossy image record sheet. As illustrated in FIG. 1, an image P is formed on a surface of a transparent recording sheet S12 (image surface). The image P is a mirror image of an original image including text and/or graphics, formed with toner by an electrographic image forming apparatus. The recording sheet S12 and an opaque cover sheet S11 including a base S14 and an adhesion layer S13 are temporarily bonded together and then united with pressure by a pair of pressure rollers 17. More specifically, the adhesion layer S13 of the cover sheet S11 is laid over the image surface of the recording sheet S12, sandwiching the image P therebetween, to produce a glossy image record sheet S25 illustrated in FIG. 2.

However, when the two sheets are bonded together as described above, air bubbles C are likely included therebetween as illustrated in FIG. 1, and then the temporarily bonded sheet passes between the pressure rollers 17 together with the air bubbles C.

As a result, the image record sheet S25 illustrated in FIG. 2 includes the air bubbles C between the recording sheet S12 and the cover sheet S1. The air bubbles C included in the image record sheet S25 cause diffuse reflection of light, giving the image record sheet S25 a turbid white that degrades the image quality. Moreover, the presence of the air bubbles C can cause the image record sheet S25 to wrinkle.

### SUMMARY OF THE INVENTION

In view of the foregoing, various illustrative embodiment of the present invention disclosed herein can provide bonded sheets with enhance quality.

In an illustrative embodiment of the present invention, a sheet bonding machine for bonding a first sheet and a second sheet together includes a transport part, an angling member, and a pressure bond part. The transport part is configured to transport the first sheet and the second sheet and contact the first sheet and the second sheet against each other at a predetermined angle. The angling member is configured to bend at least one of the first sheet and the second sheet. The pressure bond part is provided downstream of a contact position between the first sheet and the second sheet to bond together with pressure the first sheet and the second sheet contacted against each other.

In another illustrative embodiment of the present invention, a sheet bonding method includes transporting a first sheet and a second sheet, contacting the first sheet and the second sheet against each other at a predetermined angle, bending at least one of the first sheet and the second sheet, and bonding together with pressure the first sheet and second sheet contacted against each other.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an example of a bonding process of an image record sheet according to a related art method;

FIG. 2 is a cross section view of the image record sheet illustrated in FIG. 1 in which air bubbles are included;

FIG. 3 is a schematic view of an image forming apparatus according to an illustrative embodiment of the present invention;

FIG. 4 is a schematic view of a configuration around a photoreceptor drum included in the image forming apparatus illustrated in FIG. 3;

FIG. 5 is a schematic view of a sheet bonding machine according to an illustrative embodiment of the present invention in which a separation plate is at a first position;

FIG. 6 is an enlarged view of a configuration around the separation plate included in the sheet bonding machine illustrated in FIG. 5;

FIG. 7 illustrates another separation plate according to an illustrative embodiment of the present invention;

FIG. 8 is another schematic view of the sheet bonding machine illustrated in FIG. 5 in which the separation plate is at a second-position;

FIG. 9 is an enlarged view of a configuration around the separation plate illustrated in FIG. 8;

FIG. 10 illustrates a state in which air bubbles are being included between a transparent sheet and an opaque sheet;

FIG. 11 illustrates a cross section of the transparent sheet and opaque sheet bonded together;

FIG. 12 illustrates a cross section of a transparent sheet and an opaque sheet bonded together;

FIG. 13 illustrates a variety of transparent sheets;

FIG. 14 is a schematic view of a sheet bonding machine according to another illustrative embodiment of the present invention;

FIG. 15 illustrates a separation plate included in the sheet bonding machine illustrated in FIG. 14 folding a backing sheet to remove the backing sheet from a plurality of cover sheets;

FIG. 16 illustrates structures of a recording medium and the cover sheet when bonding of two sheets is started;

FIG. 17 illustrates a cross section of an image record sheet formed through a method according to an illustrative embodiment of the present embodiment;

FIG. 18 illustrates a greeting card as an image record sheet formed through a method according to an illustrative embodiment of the present embodiment; and

FIG. 19 illustrates a flow of processes to form an image record sheet according to an illustrative embodiment of the present embodiment.

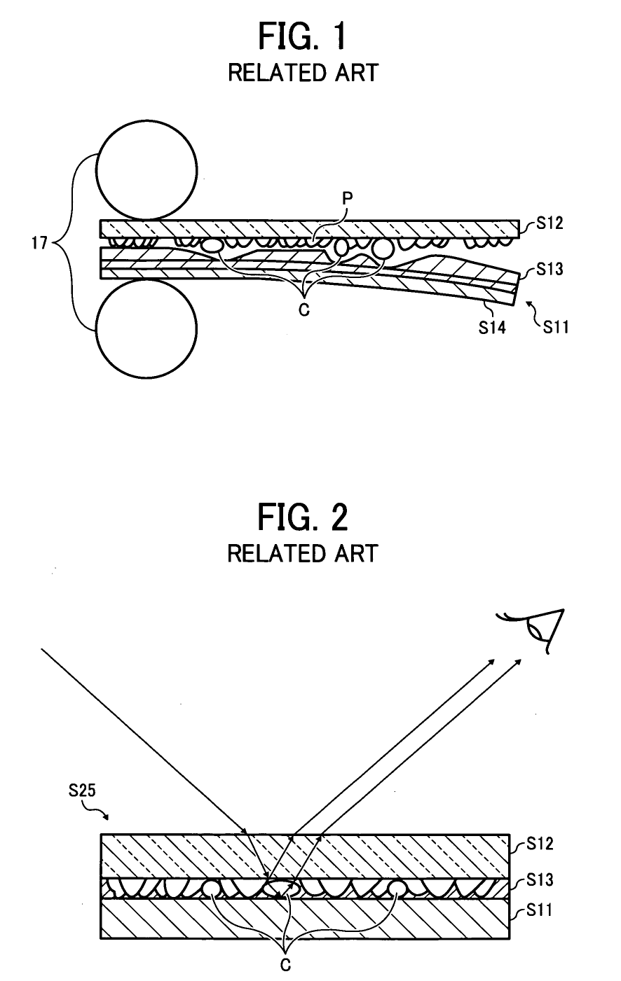

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

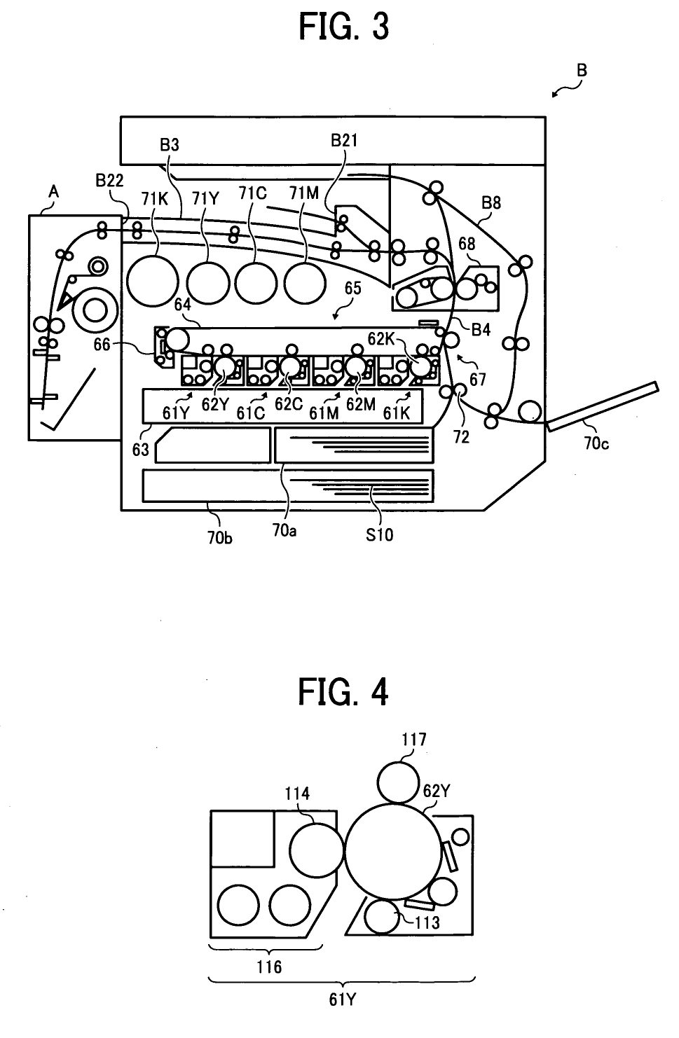

Referring now to the drawings, wherein like reference numerals designate identical or corresponding parts throughout the several views thereof, and particularly to FIG. 3, an electronographic image forming apparatus B according to an example embodiment of the present invention is described. The image forming apparatus B is capable of color image forming and provided with a sheet bonding machine A. In the example shown in FIG. 3, the sheet bonding machine A is attached to the image forming apparatus B externally.

Referring to FIG. 3, the image forming apparatus B includes image forming units 61Y, 61C, 61M, and 61K for forming yellow, cyan, magenta, and black images, respectively. It is to be noted that the image forming units 61Y, 61C, 61M, and 61K may be arranged differently from the arrangement sequence illustrated in FIG. 3.

The image forming units 61Y, 61C, 61M, and 61K include photoreceptor drums 62Y, 62C, 62M, and 62K as image carriers, respectively. The image forming units 61Y, 61C, 61M, and 61K are arranged so that rotary shafts of the photoreceptor drums 62Y, 62C, 62M, and 62K are aligned parallel to each other at a given interval.

Beneath the image forming units 61Y, 61C, 61M, and 61K, an optical writing unit 63 is provided. The optical writing unit 63 includes a light source, a polygon mirror, an f-θ lens, a reflection mirror, etc., although not illustrated in FIG. 3, and directs laser light onto surfaces of the photoreceptor drums 62Y, 62C, 62M, and 62K according to image information while scanning. Above the image forming units 61Y, 61C, 61M, and 61K, a primary transfer unit 65 is provided. The primary transfer unit 65 serves as a belt driving device and includes a transfer and transport belt 64. The yellow, cyan, magenta, and black images formed by the image forming units 61Y, 61C, 61M, and 61K are transferred onto the transfer and transport belt 64.

The transfer and transport belt 64 transports the yellow, cyan, magenta, and black images so as to superimpose these images one on another, forming a full color toner image on the transfer and transport belt 64. A cleaner 66 including a brush roller and a cleaning blade is provided so as to contact an outer circumferential surface of the transfer and transport belt 64. The cleaner 66 removes foreign materials such as toner from the transfer and transport belt 64 after a secondary transfer unit 67 transfers the toner image onto a sheet of recording medium.

In FIG. 3, the secondary transfer unit 67 is provided on the right of the primary transfer unit 65, and a belt type fixer 68 is provided above the secondary transfer unit 67.

The image forming apparatus B further includes a sheet cassettes 70a and 70b and a manual feed tray 70c. The sheet cassettes 70a and 70b are located in a bottom portion of the image forming apparatus B and contain recording sheets S10 as recording media. A user can feed recording sheets S10 manually through the manual feed tray 70c located on a side of the image forming apparatus B.

The image forming apparatus B further includes toner containers 71Y, 71C, 71M, and 71K, a sheet exit B21, an external connection port B22, a sheet stack part B3, a sheet transport path B4, a reverse path B8, and a pair of registration rollers 72. The recording sheets S10 are fed from one of the sheet cassette 70a and 70b and manual feed tray 70c and then transported through the sheet transport path B4 to one of the sheet exit B21 and the external connection port B22. The reverse path B8 connects to an upstream portion and a down stream portion of the sheet transport path B4. When images are recorded on both sides of a recording sheet S10, the recording sheet S10 is returned to the secondary transfer unit 67 through the reverse path B8 after an image is fixed on one side thereof by the fixer 68.

The sheet exit B21 discharges recording sheets S10 onto the sheet stack part B3 located inside a housing of the image forming apparatus B, and the external connection port B22 discharges recording sheets S10 from a side of the image forming apparatus B after the recording sheets S10 pass the fixer 68. The sheet bonding machine A according to the present embodiment is connected to the image forming apparatus B so as to be able to receive the recording sheets S10 discharged from the external connection port B22.

It is to be noted that, when the image forming apparatus B performs image forming in coordination with the sheet bonding machine A, the image forming apparatus B forms a mirror image on a transparent recording sheet S10 (first sheet) on which an image is recordable.

The image forming apparatus B further includes a used toner bottle, a power source unit, and a controller including an operation panel, although not shown in FIG. 3. The controller controls the entire image forming apparatus B and the sheet bonding machine A via an interface.

The image forming apparatus B configured as described above forms a toner image with small-particle polymerized toner, transfers the toner mage onto the recording sheet S10, and fixes the toner image thereon through a known electronographic method, and then discharges the recording sheet S10 through one of the sheet exit B21 and the external connection port B22.

FIG. 4 illustrates the image forming unit 61Y that forms yellow images, included in the image forming apparatus B shown in FIG. 3. The image forming unit 61Y includes a charging roller 113, a developing device 116 including a developing roller 114, and a primary transfer roller 117 around the photoreceptor drum 62Y. The image forming units 61C, 61M, and 61K are configured similarly to the image forming unit 61Y, and thus descriptions thereof omitted.

An image forming method according to an example embodiment is described below.

The power source unit, not shown, applies a predetermined or desirable voltage to the charging roller 113, and the charging roller 113 charges the surface of the photoreceptor drum 62Y facing the charging roller 113 while the photoreceptor drum 62Y rotates. The optical writing unit 63 directs laser light according to image information onto the surface of the photoreceptor drum 62Y that is charged to a predetermined or desirable potential, thus forming an electrostatic latent image on the photoreceptor drum 62Y. When the electrostatic latent image on the surface of the photoreceptor drum 62Y reaches a position to face the developing roller 114, the developing roller 114 supplies toner thereto, and a toner image is formed thereon.

The processes described above are performed in each of the image forming units 61Y, 61C, 61M, and 61K at a predetermined or desirable timing, and thus yellow, cyan, magenta, and black images are formed on the surfaces of the photoreceptor drums 62Y, 62C, 62M, and 62K, respectively.

Referring to FIG. 3, a recording sheet S10 is transported from one of the sheet cassettes 70a and 70b and the manual feed tray 70c to the registration rollers 72, along with the image forming processes described above. The primary transfer rollers 117 transfers the toner images from the photoreceptor drums 62Y, 62C, 62M, and 62K onto the transfer and transport belt 64 sequentially. More specifically, the power source unit, not shown, applies a voltage having a polarity opposite the polarity of the toner images to each of the primary transfer rollers 117 facing the photoreceptor drums 62Y, 62C, 62M, and 62K via the transfer and transport belt 64, respectively. While the transfer and transport belt 64 moves rotatably and passes positions to face the photoreceptor drums 62Y, 62C, 62M, and 62K, the toner images are superimposed one on another thereon.

The secondary transfer unit 67 transfers the superimposed toner image from the transfer and transport belt 64 onto the recording sheet S10 sent by the registration rollers 72. The recording sheet S10 is further transported to the fixer 68 where the toner image is fixed thereon with heat and pressure. After the toner image is fixed, the recording sheet S10 is transported to the sheet bonding machine A by transport rollers.

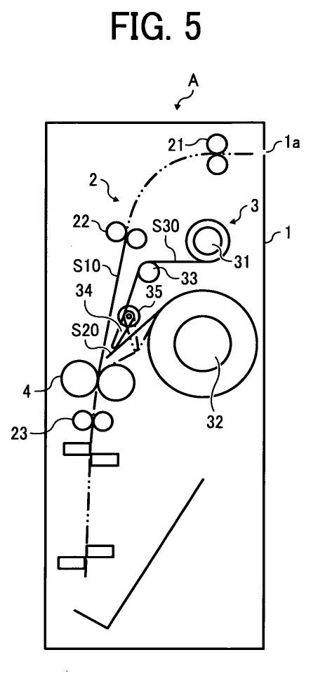

FIG. 5 is a schematic illustration of the sheet bonding machine A. As illustrated in FIG. 5, the sheet bonding machine A includes a housing 1 that forms an outline of the sheet bonding machine A.

The housing 1 is configured to be detachably connectable to the image forming apparatus B shown in FIG. 3 and includes an inlet 1a, an electrical connection, not shown, and a mechanical connection, not shown, in an upper portion of a side thereof. The inlet 1a communicates with the external connection port B22 of the image forming apparatus B. Further, the housing 1 is shaped like a box and houses a transport part 2, a reel part 3, a pair of pressure rollers 4 as a pressure bond part. The transport part 2 and the reel part 3 constitute a transport part.

The transport part 2 includes a pair of first rollers 21 rotatably provided in a portion adjacent to the inlet 1a, a pair of second rollers 22 rotatably provided to an lower left of the pair of first rollers 21 in FIG. 5, a pair of third rollers 23 rotatably provided to a lower left of the pair of second rollers 21 in FIG. 5, and a guide wall, not shown. The transparent recording sheet S10 (first sheet) on which a mirror image is formed is discharged substantially horizontally from the external connection port B22 of the image forming apparatus B to the inlet 1a, and the transport part 2 transports the recording sheet S10 along a curved transport path to a lower portion of the sheet bonding machine A. Further, the transport part 2 can control rotation of the first, second, and third rollers 21, 22, and 23 according to control commands from the controller of the image forming apparatus B.

The reel part 3 includes a reel shaft 31, a support shaft 32, an idle shaft 33, a separation plate 34 as a angling member, and a rotary solenoid 35. The reel shaft 31 is located substantially beneath the pair of first rollers 21, to the right of the pair of second rollers 22, and rotation thereof is controllable. The support shaft 32 is provided rotatably at a given position that is substantially beneath the reel shaft 31. The idle shaft 33 is provided rotatably between the reel shaft 31 and the support shaft 32 in a horizontal direction, to the left thereof.

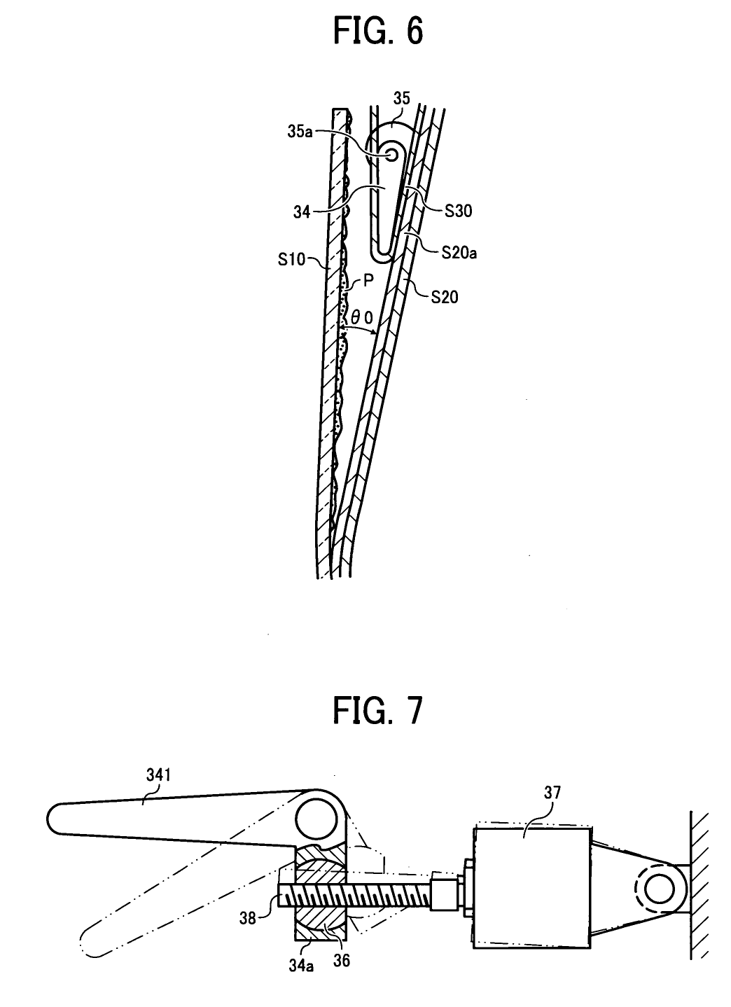

The reel part 3 feeds a rolled sheet including a plurality of opaque cover sheets S20 (second sheet) removably adhered to a continuous release paper S30 in a longitudinal direction of the release paper S30. The release paper S30 is a backing sheet of the cover sheets S20. The cover sheet S20 is white paper and sized for a given length. The sheet is rolled with the cover sheets S20 inside. FIG. 6 is an enlarged view illustrating a configuration around the separation plate 34. As illustrated in FIG. 6, the cover sheet S20 includes an adhesion layer S20a on one side thereof, and a release layer of the release paper S30 and the adhesion layer S20a stick together. The mirror image P is formed on an image surface of the recording sheet S10.

The separation plate 34 is shaped like a strip whose width in a direction perpendicular to a longitudinal direction thereof decreases gradually and includes a first end portion having a smaller width and a second end portion having a larger width. The separation plate 34 is able to swing for a predetermined or desirable angle. In FIG. 5, the separation plate 34 is at a first position (initial position) and obliquely provided so that the first end portion is at a given angle to a sheet transport path between the pair of second rollers 22 and the pair of third rollers 23.

Further, as illustrated in FIGS. 5 and 6, the first end portion of the separation plate 34 is roundish so as to facilitate smooth folding of the release paper S30 and curvature separation of the cover sheet S20 removably adhered to the release paper S30. The cover sheets S20 are not folded back by separation plate 34 together with the release paper S30 and separated from the release paper s30 because its rigidity is higher than that of the release paper S30. In the second end portion of the separation plate 34, a rotary shaft 35a of the rotary solenoid 35 is inserted as illustrated in FIG. 6. The separation plate 34 is swung by rotation of the rotary shaft 35a.

It is to be noted that, although so-called on-off type solenoid can be used, a pulse driven latch type (self hold type) solenoid is preferable as the rotary solenoid 35 because rotation speed and rotation angle can be controlled more easily.

Further, although the separation plate 34 is swung by the rotary solenoid 35 in the description above, the separation plate 34 may be swung by another mechanism. For example, the second end portion of the separation plate 34 may be pivotally supported on a fixed portion, such as the housing 1, etc., and the separation plate 34 and the fixed portion may be connected via a linear solenoid so that the separation plate 34 can be swung by expansion and contraction of the linear solenoid.

FIG. 7 illustrates a separation plate 341 as another example of the angling member. Similarly to the separation plate 34 illustrated in FIGS. 5 and 6, the separation plate 341 is shaped like a strip and includes a roundish first end portion having a smaller width and a second end portion having a larger width. The second end portion is pivotally supported on a fixed portion, such as the housing 1 illustrated in FIG. 5. The separation plate 341 further includes an arm 34a extending from the second end portion in which a nut 36 fits loosely. As illustrated in FIG. 7, the nut 36 is shaped like a sphere whose edge portions are cut off and has a predetermined or desirable width. The nut 36 engages a screw bar 38 that is driven by a motor 37. The separation plate 341 is swung by rotation of the screw bar 38. In this case, the nut 36 is configured not to be rotated by rotation of the screw bar 38, and a base of the motor 37 is pivotally supported on the fixed portion. The separation plate 341 operates in a similar manner and achieves a similar result to the separation plate 34 illustrated in FIGS. 5 and 6.

Setting of the rolled sheet including the cover sheets S20 and the release paper S30 is described below with reference to FIG. 5.

As illustrated in FIG. 5, the rolled sheet is set on the support shaft 32 so as to be unreeled by counterclockwise rotation of the support shaft 32. The separation plate 34 folds only the release paper S30 from the unreeled sheet, and the release paper S30 is then wound around the idle shaft 33 partly. The release paper S30 is further set on the reel shaft 31 so as to be reeled by counterclockwise rotation of the reel shaft 31.

In the reel part 3, when the reel shaft 31 rotates according to a control command from the controller of the image forming apparatus B, the rolled sheet set on the support shaft 32 is unreeled, and further the cover sheet S20 is separated from the release paper S30 while the separation plate 34 folds the release paper S30. The separated cover sheet S20, which is able to adhere on the recording sheet S10 transported by the transport part 2, is forwarded obliquely toward the transport direction of the recording sheet S10 (sheet transport direction).

In the present embodiment, the recording sheet S10 and the cover sheet S20 are transported so as to contact against each other. While the cover sheet S20 is obliquely transported toward the sheet transport direction of the recording sheet S10, the release paper S30 removed from the cover sheet S20 is reeled on the reel shaft 31.

It is to be noted that the initial position of the separation plate 34 is set so that the recording sheet S10 and the cover sheet S20 contact against each other at an initial angle θ0 with which fully bonding is available therebetween with a reduced impact. After the recording sheet S10 and the cover sheet S20 contact each other and are slightly bonded together, the separation plate 34 changes its position at a predetermined or desirable timing. The angle between the recording sheet S10 and the cover sheet S20 is hereinafter referred to as the bonding angle.

The pair of pressure rollers 4 is located slightly downstream of a contact position between the recording sheet S10 and the cover sheet S20 in the sheet transport direction, in the sheet transport path between the pair of second rollers 22 and the pair of third rollers 23. The pressure rollers 4 sandwich the recording sheet S10 and the cover sheet S20 therebetween and these sheets against each other so as to be fully bonded.

The sheet bonding machine A configured as described above detachably connects to the image forming apparatus B and performs a sequence of processes described below.

Referring to FIG. 3, the user selects an output mode to use the sheet bonding machine A from the operation panel on the image forming apparatus B and starts the processes to form an image P on the recording sheet S10. The image P is formed based on an image read by a scanner, not shown, provided on the image forming apparatus B or an electrical image transmitted from an electrical device including computers and digital cameras. It is to be noted that, although the recording sheet S10 may be fed from one of the sheet cassettes 70a and 70b and the manual feed tray 70c, feeding of the recording sheet S10 is not limited thereto.

The image P is developed into a toner image with small particle polymerized toner, transferred onto the recording sheet S10, and fixed thereon through a known electronographic method. After passing the fixer 68, the recording sheet S10 is transported with its image surface down, discharged from the external connection part B22, and then forwarded into the sheet bonding machine A through the inlet 1a illustrated in FIG. 5.

In the sheet bonding machine A, the transport part 2 transports the recording sheet S10 downward, and the reel shaft 31 starts to rotate according to a control command from the controller of the image forming apparatus B, and the rolled sheet set on the support shaft 32 is unreeled. Further, the separation plate 34 removes the release paper S30 from the cover sheet S20, and the cover sheet S20 is obliquely forwarded so as to contact against the recording sheet S10. It is to be noted that the recording sheet S10 and the cover sheet S20 are transported at an identical or similar speed.

Referring to FIGS. 5 and 6, the cover sheet S20 is transported toward the sheet transport direction and contacts a leading edge of the recording sheet S10 at the predetermined or desirable angle θ0 that is determined by layout of the transport part 2 and the reel part 3, and the first position of the separation plate 34 as illustrated in FIGS. 5 and 6. Thus, reliable bonding between the recording sheet S10 and the cover sheet S20 can be started with the contact impact therebetween reduced.

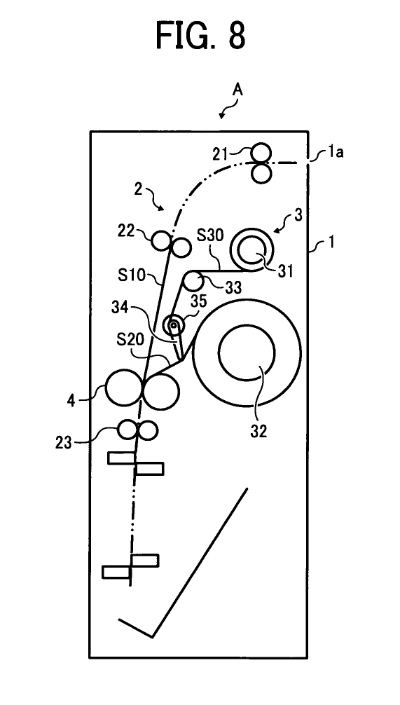

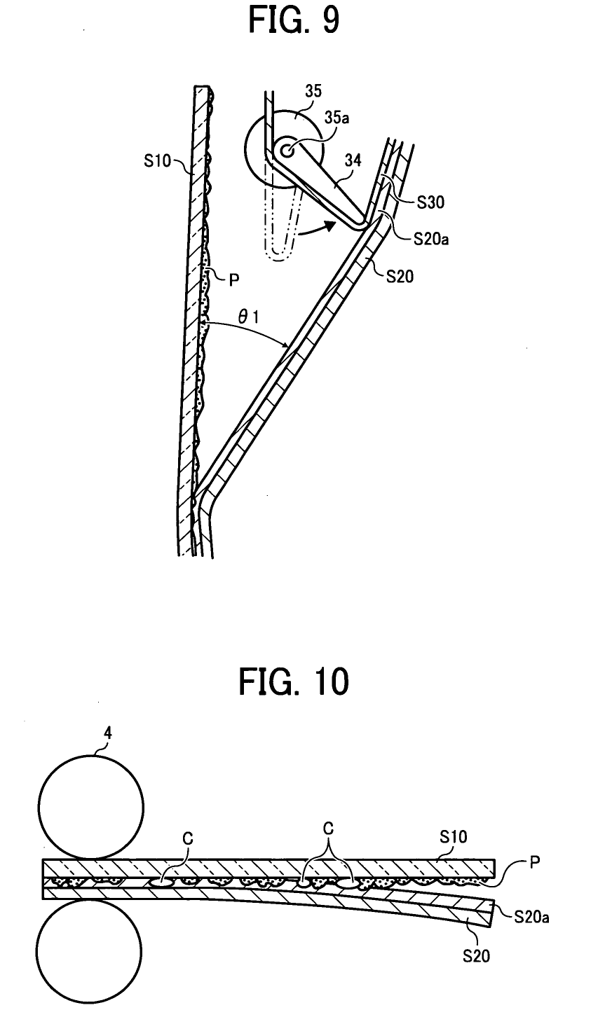

Immediately after bonding of the recording sheet S10 and the cover sheet S20 is started, or the these sheets are bonded over a predetermined or desirable length, the rotary solenoid 35 is activated by a control signal from the controller. Further, the separation plate 34 swings counterclockwise to a second position to press and bend the cover sheet S20 adhered on the release paper S30 as illustrated in FIGS. 8 and 9. In other words, the separation plate 34 changes a transport direction of the cover sheet S20. When the separation plate 34 is at the second position, the cover sheet S20 thus curves at the separation plate 34 and is forwarded at an angle set by the separation plate 34, and the bonding angle, at which the cover sheet S20 adheres on the recording sheet S10, is increased to an enlarged angle θ1 as illustrated in FIG. 9. Thus, air bubbles entering between the recording sheet S10 and the cover sheet S20 are reduced or prevented by increasing the bonding angle from the initial angle θ0 to the enlarged angle θ1.

Further, alternatively, the timing with which the separation plate 34 changes the bonding angle from the initial angle θ0 to the enlarged angle θ1 (angle change timing) may be simultaneous with a timing when the leading edge of the bonded sheet reaches the pressure rollers 4. In both cases, the angle change timing may be controlled temporally by measuring time. Alternatively, the angle change timing may be controlled by sensing a contact state between the leading edges of the recording sheet S10 and the cover sheet S20 or arrival of the leading edge of the bonded sheet at the pressure rollers 4.

The control of the angle change timing is not limited to the description above.

The recording sheet S10 and the cover sheet S20 stick together until trailing edges thereof lap over each other. While the recording sheet S10 and the cover sheet S20 thus stick together, the portion thereof contacted against each other is immediately sandwiched between the pressure rollers 4 and bonded together with pressure.

After the trailing edge of the bonded sheet passes between the pair of third rollers 23 and thus bonding is completed, the separation plate 34 returns to the first position (initial position), the reel shaft 31 stops rotating, and the bonded sheet is discharged to a discharge space provided in a lower portion of the housing 1, as an image record sheet. After the image record sheet is thus discharged, the transport part 2 stops transportation and enters a standby state until next bonding is started. Thus, the sequence of the processes performed by the sheet bonding machine A according to the present embodiment is completed.

It is to be noted that the bonding angle between the recording sheet S10 and the cover sheet S20 is changed from the initial angle θ0 to the enlarged angle θ1 at such a speed that facilitates smooth unreeling of the cover sheet S20 adhered to the release paper S30. In an example, the speed may be gradually changed so that the bonding angle becomes the enlarged angle θ1 when the recording sheet S10 and the cover sheet S20 are completely bonded or slightly before the bonding is completed.

The bonding angle has the following relations with air bubbles entering bonded sheets.

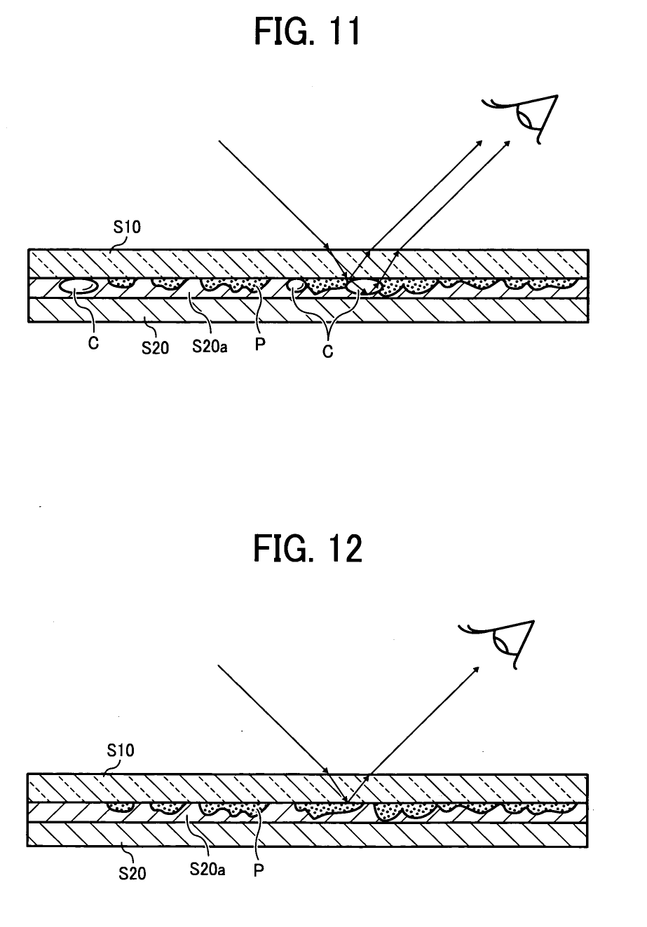

For example, as illustrated in FIG. 10, air bubbles C tend to enter the bonded sheet due to unevenness of the adhesion layer S20a and/or slight jolting of the sheets when the bonding angle is about between 10 degrees and 45 degrees, although the contact impact between the recording sheet S10 and the cover sheet S20 can be reduced. Even small air bubbles C degrade quality of an image record sheet (bonded sheet) because the air bubbles C cause diffuse reflection of light as illustrated in FIG. 11.

By contrast, for example, when the bonding angle is about between 30 degrees and 90 degrees, reducing the contact impact between two sheets is difficult. However, after bonding is started, the air bubbles C entering the bonded sheet can be greatly reduced or prevented. In the present embodiment, the bonding angle is changed from the initial angle θ0 to the enlarged angle θ1 by moving the separation plate 34, and thus the sheets are reliably bonded with less or no air bubbles between the bonded sheet.

As illustrated in FIG. 12, the transparent recording sheet S10 and the opaque cover sheet S20 are bonded with the image P sandwiched therebetween, and thus a photographic image record sheet having a normal image is produced. Particularly, using small-particle polymerized toner reduces the height of the toner image, which reduces air bubbles entering the bonded sheet as well as enhances image quality.

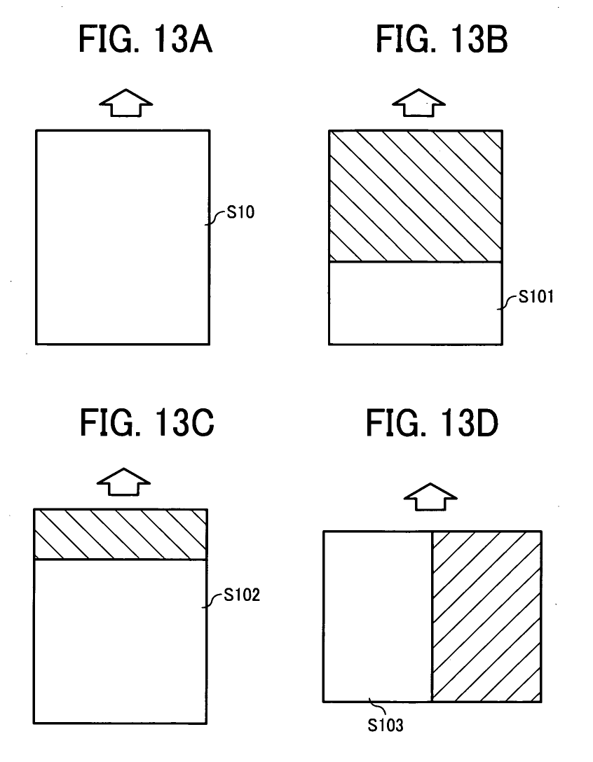

It is to be noted that, although the recording sheet S10 is entirely transparent in the description above as illustrated in FIG. 13A, the transparent recording sheet S10 is not limited thereto. Alternatively, recording sheets S101, S102, and S103 illustrated in FIGS. 13B, 13C, and 13D, respectively, that include a partial opaque portion may be used. In FIGS. 13A through 13D, the opaque portions are shown by parallel diagonal lines, and other portions are transparent.

It is to be noted that, although the bonding angle is changed by moving the separation plate 34 that is the angling member in the description above, alternatively, the angling member may be a controllable guide plate that bendably presses the recording sheet S10 or the cover sheet so as to change its transport direction. In this case, it is preferable that the guide plate have a simple configuration similarly to the separation plate 34.

Further, in addition to the separation plate 34 or such a guide plate, the bonding angle may be changed by moving the transport parts 2 and/or the reel part 3. In this case, it is preferable to unite the transport part 2 and/or the reel part 3 to move together.

Further, although an image is formed on the transparent recording sheet S10 that is to be bonded with the opaque cover sheet S20 in the description above, the image may be formed on a white opaque sheet that is to be bonded with a transparent sheet.

Although the description above concerns a sheet bonding machine that functions in coordination with an image forming apparatus, the present invention may be applied to any device that bonds sheets, not limited to such a device to output image record sheets.

Further, the present invention may be applied to a sheet bonding method including changing the transport direction of at least one of a first sheet and a second sheet so as to change the bonding angle between these two sheets, and bonding together the first sheet and the second sheet. Also in this sheet bonding method, the initial angle θ0 and the enlarged angle θ1, and the angle change timing described above are preferable.

Further, the present invention may be applied to a method of producing an image record sheet including bonding first and second sheets with an image sandwiched therebetween. In this method, it is preferable to form a mirror image with small-particle polymerized toner on a transparent sheet and to bond the transparent sheet with an opaque sheet, such as a white sheet.

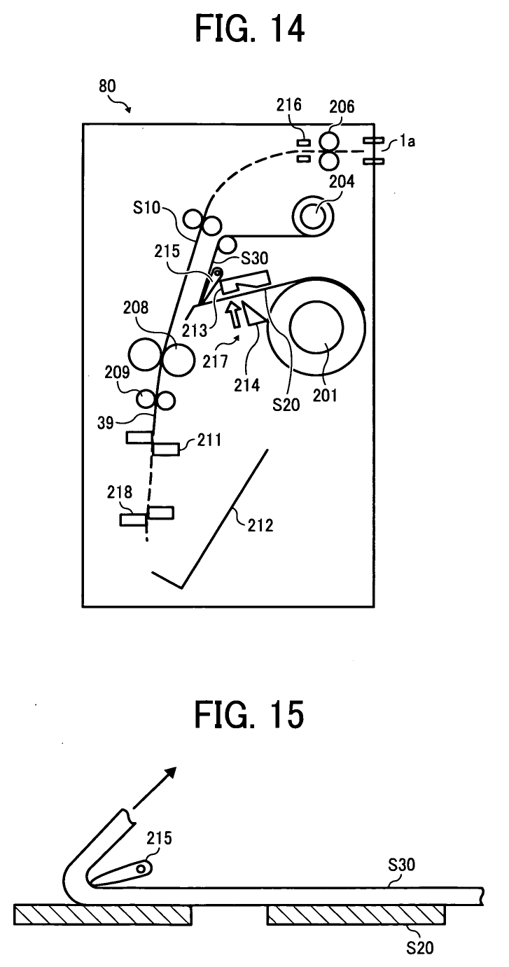

FIG. 14 illustrates a sheet bonding machine 80 according to another embodiment of the present invention. The sheet bonding machine 80 uses a rolled sheet including a plurality of cover sheets S20 that are cut into a predetermined or desirable size and adhered to a continuous release paper S30 as a backing sheet. The rolled sheet is supported by a support shaft 201. The cover sheet S20 includes an adhesion layer and is detachably adhered to a release paper S30. The release paper S30 may be a release paper coated with silicon resin or a heat resistant seal.

The sheet bonding machine 80 includes a reel roller 204, pairs of transport rollers 206 and 209, a pair of pressure rollers 208 (pressure bond part), a discharge tray 212, angling members 213 and 214, a separation plate 215, a sensor 216, and cutters 211 and 218.

While the rolled sheet including the cover sheets S20 adhered to the release paper S30 is unreeled, the separation plate 215 separates the cover sheet S20 from the release sheet S30 as illustrated in FIG. 15. After the cover sheet S20 is separated, the release paper S30 is reeled on the reel roller 204. To separate the cover sheet S20 from the release sheet S30 through curvature separation with the separation plate 215, the rolled sheet is set so that the cover sheet S20 is sandwiched between the separation plate 215 and the release paper S30.

The angling members 213 and 214 constitute an angling mechanism 217 that guides the cover sheet S20 so as to angle a leading edge portion of the cover sheet S20 to a predetermined or desirable angle. As illustrated in FIG. 14, the angling member 213 includes a groove and is fixed not to move. When the cover sheet S20 reaches a predetermined or desirable position, the sensor 216 activates the angling member 214 so as to push the cover sheet S20 into the groove of the angling member 213, and thus a curved portion is formed in a leading edge portion of the cover sheet S20.

It is to be noted that the angling members 213 and 214 should be located upstream of the separation plate 215 that separates the cover sheet S20 from the release paper S30 in the transport direction of the cover sheet S20. Otherwise, the adhesion layer of the cover sheet S20 will adheres on the angling member 213.

By using the angling mechanism 217 described above, the leading edge portion of the cover sheet S20 can be angled automatically and easily before bonding.

Further, a recording sheet S10 including an image surface on which a mirror image is formed is sent from an image forming apparatus such as the image forming apparatus B illustrated in FIG. 3 through an inlet 1a. The recording sheet S10 is located so that the image surface faces the cover sheet S20. The transport rollers 206 forward the recording sheet S10 toward the pressure rollers 4.

The cover sheet S20 is separated by the separation plate 215 from the release paper S30 and forwarded toward the pressure rollers 208 in such a timely manner that its leading edge is contacted against a leading edge of the recording sheet S10. Thus, the recording sheet S10 and the cover sheet S20 are bonded as an image record sheet.

The cutter 211 cuts off two parallel edge portions of the image record sheet so as to size a length of the image record sheet for the longitudinal length of a standard photograph size. By cutting off the edge portion including the portion curved by the angling members 213 and 214, a satisfactory image record sheet without deformation can be obtained. Examples of the cutter 211 include, but are not limited to, a slitter.

The image record sheet is then rotated for about 90 degrees and sent to the cutter 218 so that the cutter 218 cuts off the other two parallel edge portions of the image record sheet. The image record sheet is then discharged onto the discharge tray 212. Thus, the edge portions of the image record sheet in which the record sheet S10 and the cover sheet S20 might not be aligned are removed by the cotters 211 and 218, and an image record sheet with uniform edge surfaces is obtained.

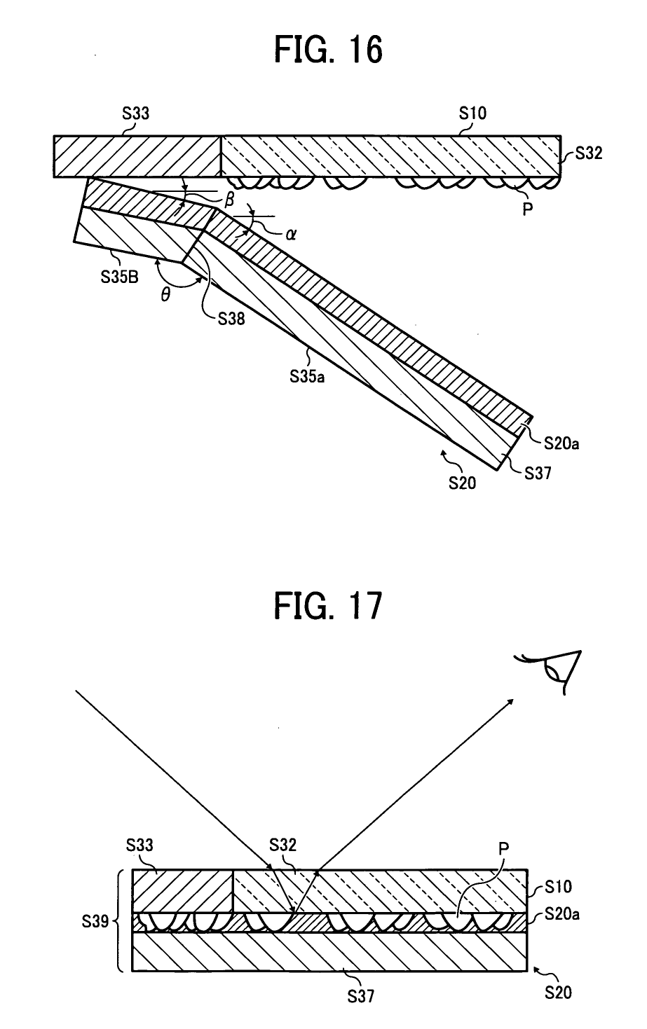

Referring to FIGS. 16 through 18, forming a greeting card including a glossy image as an image record sheet according to an example embodiment is described below.

FIG. 16 illustrates structures of the record sheet S10 and the cover sheet S20, and angling of the cover sheet S20. As illustrated in FIG. 16, the recording sheet S10 includes a transparent portion S32 and an opaque portion S33. As described above, the recording sheet S10 includes the image surface on one side, and an image P that is a mirror image of a color original image including text and/or graphics is formed thereon through an electronographic method or ink-jet method. The image P can be enlarged or reduced from the original image. The mirror image P can be formed through digital processing.

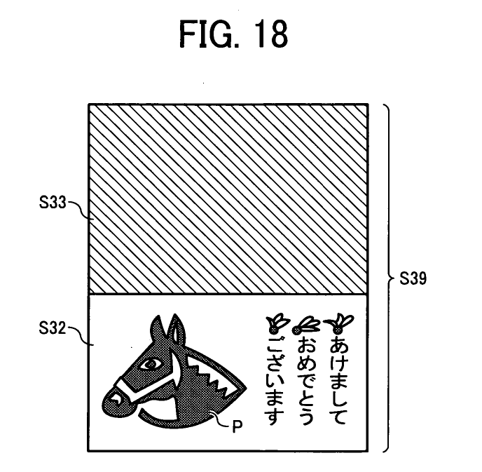

The cover sheet S20 is opaque and divided into a first portion S35B that includes a leading edge and a second portion S35A excepting the first portion S35B. The first portion S35B (leading edge portion) is angled by the angling mechanism 217 illustrated in FIG. 14 so as to form a curved portion S38 between first portion S35B and the second portion S35A. The cover sheet S20 includes a transparent or opaque adhesion layer S20a formed on a base S37, thus forming an adhesion surface. The cover sheet S20 is laid over the recording sheet S10 from the leading edge of the cover sheet S20 to cover the image P, and image surface of the record sheet S10 and adhesion surface of the cover sheet S20 stick together due to adhesion of the adhesion layer S20a, thus forming an image record sheet S39 illustrated in FIG. 17.

It is preferable that the image P be not located in a portion corresponding to the curved portion S38 of the cover sheet S20.

The adhesion layer S20a is formed on one side of the base S37 and protected with the release paper S30 before the cover sheet S20 is contacted against the recording sheet S10. Alternatively, a heat sensitive adhesive, which develops adhesion after passing a heating part that can be provided as a final process, may be used.

When the adhesion layer S20a is opaque, the adhesion layer S20a is used as a background of the image record sheet S39. By contrast, when the adhesion layer S20a is transparent, a surface of the opaque portion S33 becomes the background of the image record sheet S39. To reflect color and/or pattern of the opaque portion S33 in the background of the image record sheet S39, the adhesion layer S20a is preferably transparent. By contrast, when the color and/or pattern of the opaque portion S33 is not reflected on the background of the image record sheet S39, the adhesion layer S20a may be colored with while or any other color suitable for background. As the color of the adhesion, white is a suitable background color for various images.

As illustrated in FIG. 16, the cover sheet S20 is bent so that the first portion S35B and the second portion S35A form an angle θ at the curved portion S38. The first portion S35B is curved to an extent that the angle θ is less than 180 degrees with reference to the second portion S35A on a base side thereof. In this state, the adhesion surface of the second portion S35A forms an angle α with a surface parallel to the image surface of the recording sheet S10 from the curved portion S38 toward a trailing edge of the cover sheet S20, and the adhesion surface of the first portion S35B forms an angle β with the surface parallel to the image surface of the recording sheet S10.

By starting bonding of the recording sheet S10 and the cover sheet S20 when the angle α is greater than the angle β, air bubbles entering in the recording sheet S39 illustrated in FIG. 17 can be reduced or prevented.

It is to be noted that the condition described above includes a case in which the angle θ is relatively acute because the angle α is necessarily greater than the angle β when the angle θ is relatively acute.

By contrast, for reliable bonding, it is preferable that the angle between the first portion S35B (leading edge portion) of the cover sheet S20 and the recording sheet S10 be smaller, that is, the first portion S35B roughly parallels the recording sheet S10.

Bonding of the record sheet S10 including at least one transparent portion and the cover sheet S20 is started at liner or planar contact between the first portion S35B of the cover sheet S20 and the recording sheet S10, and then the recording sheet S10 and the cover-sheet S20 are bonded together slightly and sandwiched between the pressure rollers 208 so as to be united.

When the bonded image record sheet S39 illustrated in FIG. 17 is viewed from the side of recording sheet S10 (transparent portion S32), the image P appears as a normal image on the image record sheet 39 (greeting card) as illustrated in FIG. 18. It is preferable to design the color and the pattern of the opaque portion S33 suitable for the background of the greeting card when the adhesion layer S20a illustrated in FIGS. 16 and 17 is transparent.

In the present embodiment, the cover sheet S20 is bent so that the first portion S35B and the second portion S35A form the angle θ that is less than 180 degrees at the curved portion S38, as illustrated in FIG. 16, before bonded to the recording sheet S10, and bonding is started at a proper timing with which reliable bonding is available. Thus, air bubbles entering in the recording sheet S39 can be reduced or prevented by setting the angle θ to less than 180 degrees and the angle α to an angle grater than the angle β. As a result, a glossy photographic image can be produced. Further, preventing or reducing air bubbles entering in the image record sheet can enhance storage stability of the image record sheet.

It is to be noted that difference in height (toner adhesion amount) on the recording sheet S10 between the image P and other portions can be reduced by using a polymerized toner including small particles whose particle size distribution is relatively narrow. Thus, high quality images can be produced with less or no air bubbles included between the recording sheet S10 and the cover sheet S20.

Is to be noted that recording sheet may be partially transparent, or the whole or half of the recording sheet may be transparent.

In the present embodiment, a sequence including reducing or enlarging an image according to the size of an area of a recording sheet that is determined as transparent and inverting the image into a mirror can be automatically performed. An example of the sequence is described below.

To form such a sequence with the image forming apparatus B illustrated in FIG. 3, a user selects a mode to form a photographic image on a transparent area on a recording sheet, such as photographic printing, to the image forming apparatus B. The photographic printing mode can be selected by pressing a setup button on the image forming apparatus B or an icon on a driver for the image forming apparatus B. The user then selects an image to be printed and instructs the image forming apparatus B to start image forming.

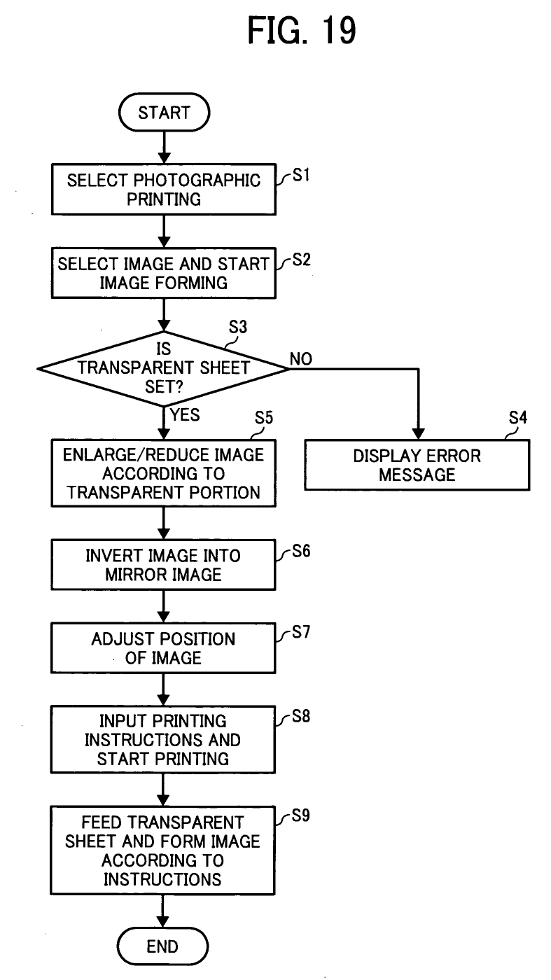

The image forming processes described above is executed by a program included in the controller, not shown, of the image forming apparatus B in the sequence illustrated in FIG. 19. More specifically, the user selects the photographic printing mode at S1, and selects an image (original image) and then instructs the image forming apparatus B to start image forming at S2. At S3, the image forming apparatus B checks whether or not a recording sheet suitable for the photographic printing mode, that is, a recording medium that is at least partially transparent, is set in the sheet cassette 70a or 70b, or on the manual feed tray 70c. If such a recording medium is not set (NO at S3), the image forming apparatus B displays an error message at S4. If such a recording sheet is set (YES at S3), the image forming apparatus B adjusts (reduce or enlarge) the size of the image according to the size of the transparent portion at S5.

At S6, the image is inverted, and a mirror image of the original image is formed. At S7, a position to start image forming is adjusted so that the mirror image is located properly in the transparent portion. At S8, the user inputs printing instructions and a command to output the image to the image forming apparatus B. At S9, the recording sheet for the photographic printing mode is transported through the image forming apparatus and the image is formed at the proper position on the recording sheet at a resolution designated by the printing instructions.

Thus, the mirror image of the original image is formed on the transparent portion of the recording sheet by the controller.

Numerous additional modifications and variations are possible in light of the above teachings. It is therefore to be understood that, within the scope of the appended claims, the disclosure of this patent specification may be practiced otherwise than as specifically described herein.

What is claimed is:

1. A sheet bonding machine to bond a first sheet and a second sheet together, comprising:
a transport part configured to transport the first sheet and the second sheet and contact the first sheet and the second sheet against each other at a predetermined angle;
an angling member configured to bend at least one of the first sheet and the second sheet; and
a pressure bond part provided downstream of a contact position between the first sheet and the second sheet, configured to bond together with pressure the first sheet and the second sheet contacted against each other.

2. The sheet bonding machine according to claim 1, wherein the angling member engages the transport part and changes an initial bonding angle between the first sheet and the second sheet by bending at least one of the first sheet and the second sheet.

3. The sheet bonding machine according to claim 2, wherein the angling member increases the bonding angle between the first sheet and the second sheet after bonding of the first sheet and the second sheet is started.

4. The sheet bonding machine according to claim 2, wherein the angling member increases the bonding angle between the first sheet and the second sheet after the first sheet and the second sheet are bonded together over a predetermined length of the first sheet and the second sheet.

5. The sheet bonding machine according to claim 1, wherein a plurality of the second sheets each having a predetermined length and removably adhered to a continuous backing sheet are passed over the angling member to remove the backing sheet from the plurality of second sheet and prepare each of the plurality of second sheets for bonding with the first sheet.

6. The sheet bonding machine according to claim 1, wherein one of the first sheet and the second sheet is transparent and the other thereof is opaque, an image is formed on one of the first sheet and the second sheet, and the image is sandwiched between the first sheet and the second sheet.

7. The sheet bonding machine according to claim 6, wherein the image is formed with small-particle polymerized toner.

8. The sheet bonding machine according to claim 1, wherein the transport part comprises
a first transporter configured to transport the first sheet, and
a second transporter configured to transport the second sheet obliquely toward a transport direction of the first sheet transported by the first transporter.

9. The sheet bonding machine according to claim 1, wherein the angling member bends the second sheet before the second sheet contacts the first sheet to form a curved portion in the second sheet,
a leading edge portion of the second sheet and another portion excepting the leading edge portion forming an angle therebetween of less than 180 degrees on a side opposite a side of the second sheet to which the first sheet is bonded.

10. The sheet bonding machine according to claim 9, further comprising:
a cutter located downstream of the pressure bond part to remove an area including the curved portion from the bonded sheet including the first sheet and the second sheet.

11. The sheet bonding machine according to claim 1, wherein the first sheet comprises a transparent portion on which a mirror image is formed and the second sheet comprises a base and an adhesion layer,
a surface of the adhesion layer and a surface of the first sheet on which the mirror image is formed being bonded together.

12. The sheet bonding machine according to claim 1, further comprising:
a sensor to sense arrival of the second sheet at a predetermined position upstream of the pressure bond part in a transport direction of the second sheet.

13. An image forming apparatus, comprising:
at least one image carrier on which an image is formed;
a transferer configured to transfer the image onto a recording medium; and
the sheet bonding machine of claim 1.

14. A sheet bonding method, comprising:
transporting a first sheet and a second sheet;
contacting the first sheet and the second sheet against each other at a predetermined angle;
bending at least one of the first sheet and the second sheet; and
bonding together with pressure the first sheet and the second sheet contacted against each other.

15. The sheet bonding method according to claim 14, wherein an initial bonding angle between the first sheet and the second sheet is increased by bending at least one of the first sheet and the second sheet after bonding of the first sheet and the second sheet is started.

16. The sheet bonding method according to claim 14, wherein an initial bonding angle between the first sheet and the second sheet is increased by bending at least one of the first sheet and the second sheet after the first sheet and the second sheet are bonded together over a predetermined length of the first sheet and the second sheet.

17. The sheet bonding method according to claim 14, further comprising:
removing a continuous backing sheet to which a plurality of the second sheets each having a predetermined length are removably adhered from the plurality of second sheets and preparing each of the plurality of second sheets for bonding with one of the first sheets.

18. The sheet bonding method according to claim 14, wherein the first sheet comprises a transparent portion on which a mirror image is formed and the second sheet comprises a base and an adhesion layer, an adhesion surface of the second sheet and an image surface of the first sheet are bonded together, and the second sheet is bent before the second sheet contacts against the first sheet to form a curved portion thereon
a leading edge portion and a second portion excepting the leading edge portion form an angle therebetween of less than 180 degrees on a side opposite a side of the second sheet to which the first sheet is bonded.

19. The sheet bonding method according to claim 18, wherein the first sheet and the second sheet are bonded when an angle formed with the image surface of the first sheet and the adhesion surface of the leading edge portion of the second sheet is smaller than an angle formed with the image surface of the first sheet and the adhesion surface of the second portion of the second sheet.

20. The sheet bonding method according to claim 18, wherein the mirror image is formed with small-particle polymerized toner.
